(19) United States
(12) Patent Application Publication
(10) Pub. No.: US 2006/0051583 A1
(43) Pub. Date: Mar. 9, 2006

(54) Size-exclusion ion-exchange particles

(75) Inventors: Aldrich N.K. Lau, Palo Alto, CA (US); Michael P. Harrold, San Mateo, CA (US)

Correspondence Address: MILA KASAN, PATENT DEPT.;APPLIED BIOSYSTEMS, 850 LINCOLN CENTRE DRIVE, FOSTER CITY, CA, 94404, US

(73) Assignee: Applera Corporation, Foster City, CA (US)

(21) Appl. No.: 11/262,036

(22) Filed: Oct. 27, 2005

Related U.S. Application Data
(62) Division of application No. 10/414,179, filed on Apr. 14, 2003.
(60) Provisional application No. 60/398,852, filed on Jul. 26, 2002.

(51) Int. Cl. B01D 15/08; B32B 5/16

(52) U.S. Cl. 428/407; 428/403; 210/502.1; 210/263; 210/198.2; 427/213

(57) ABSTRACT

A size-exclusion ion-exchange particle and a device using the particle are provided wherein the particle includes an ion-exchange core micro-encapsulated by a shell, and the shell includes a polymerization product of a reactive monomer. The shell can be an at least partially cross-linked polymer. The shell can be capable of excluding molecules of a size equal to or larger than a 10 nt ssDNA molecule or molecules of a size equal to or larger than a 100 nt ssDNA molecule, for example, and the core can be capable of ion-exchange. Methods of making size-exclusion ion-exchange particles are also provided, as are methods of purification using the particles.

### CROSS REFERENCE TO RELATED APPLICATIONS

This application is a divisional patent application which claims priority from U.S. Ser. No. 10/414,179 filed Apr. 14, 2003 which claims priority to Provisional Patent Application No. 60/398,852, filed Jul. 26, 2002, both incorporated herein by reference in their entirety.

### FIELD

The present teachings relate to apparatuses and methods for filtering and/or purifying a sample by using ion-exchange techniques.

### BACKGROUND

Purification of reaction products obtained from, for example, a polymerase chain reaction (PCR) or a sequencing reaction, can present a number of challenges for subsequent, downstream processing. Impurities can cause artifacts in subsequent processing steps. Numerous purification steps to eliminate artifacts can be cumbersome and inefficient. Further, purification, such as by size-exclusion chromatography or ion-exchange chromatography, requires a respective well-formed resin bed, without cracks, bubbles, or channels, as well as correct sample-loading techniques. Resin beds used for purification, for example, by size-exclusion, can be ten times or more the volume of the sample in size, requiring much space and increasing the cost of purification. Also, ion-exchange resins often interact undesirably with target analytes as opposed to interacting with the ions the resins are supposed to remove. Further, purification using ion-exchange materials can require elution of the analyte using a high salt eluant, which can be undesirable for subsequent analysis and/or reactions. A need exists for a purification method that addresses these and other problems associated with conventional techniques of purification.

### SUMMARY

According to various embodiments, a size-exclusion ion-exchange (SEE) particle is provided that can include a core and a shell, wherein the core comprises ion-exchange material, and the shell comprises size-exclusion material.

According to various embodiments, a method of forming a size-exclusion ion-exchange particle is provided. The method can include providing an ion-exchange core, and micro-encapsulating the ion-exchange core with a size-exclusion material. According to various embodiments, the core can be positioned in an emulsion comprising a polymerizable monomer, and the core can be micro-encapsulated by polymerizing the monomer to form a shell having pores capable of excluding material larger than a pre-determined size.

According to various embodiments, a method of purifying a sample is provided. The method can include providing such a sample, contacting the sample with one or more size-exclusion ion-exchange particles to form a purified sample, and removing/separating the purified sample from the size-exclusion ion-exchange particles.

Additional features and advantages of various embodiments will be set forth in part in the description that follows, and in part will be apparent from the description, or may be learned by practice of various embodiments. The objectives and other advantages of various embodiments will be realized and attained by means of the elements and combinations particularly pointed out in the description herein and appended claims.

### BRIEF DESCRIPTION OF THE FIGURES

FIG. 1 is a schematic diagram of an interaction of an anionic species with a size-exclusion ion-exchange particle, according to various embodiments;

FIG. 2 is a schematic diagram of the core-shell structures of a size-exclusion ion-exchange core, having cutaways to show the surface of the core and the interior of the core.

FIG. 3 is a schematic diagram showing formation of a shell on an ion-exchange core by inverse emulsification and polymerization, according to various embodiments;

FIG. 4 is a diagram illustrating the formation of a size-exclusion ion-exchange particle, according to various embodiments;

FIG. 5 is a diagram illustrating a derivatization of an ion-exchange resin;

FIG. 6 is a diagram illustrating the formation of a reactive polyanion;

FIG. 7 is a schematic diagram of the formation of a size-exclusion ion-exchange particle, wherein one step is surface activation of the ion-exchange core, according to various embodiments;

FIG. 8 is a schematic diagram of two pathways for formation of a size-exclusion ion-exchange particle, wherein one common step is surface activation of the ion-exchange core, according to various embodiments;

FIG. 9 is a series of graphs of (a) data acquired from a raw sample including a mixture of a dye-labeled amplicon and a dye-labeled primer, and data acquired after incubation of the sample with a size-exclusion ion-exchange particle according to various embodiments for (b) two minutes, (c) five minutes, and (d) ten minutes, to remove the dye-labeled primer;

FIGS. 10a and 10b demonstrate the results of sequencing a PCR product purified using size-exclusion ion-exchange particles, wherein FIG. 10a is data from sequencing a raw PCR product, and FIG. 10b is data from sequencing a PCR product as purified by contact with size-exclusion ion-exchange particles according to various embodiments;

FIGS. 11a-d demonstrate purification of a sequencing reaction by contact with size-exclusion ion-exchange particles in comparison with standard purification techniques, wherein FIG. 11a is raw data of the unpurified sample, FIG. 11b is data from a sample purified with a CentriStep column, and FIGS. 11c and 11d are data from a sample purified by contact with size-exclusion ion-exchange particles, according to various embodiments;

FIG. 12 is a graph showing, for a population, the difference in size between an anion-exchange core and a resultant SEIE particle containing the anion-exchange core, according to various embodiments; and

FIG. 13 is a graph showing, for a population, the difference in size between an anion-exchange core and a resultant SEIE particle containing the anion-exchange core, according to various embodiments.

It is to be understood that the figures are not drawn to scale. Further, the relation between objects in a figure may not be to scale, and may in fact have a reverse relationship as to size. The figures are intended to bring understanding and clarity to the structure of each object shown, and thus, some features may be exaggerated in order to illustrate a specific feature of a structure.

It is to be understood that both the foregoing general description and the following detailed description are exemplary and explanatory only, and are intended to provide an explanation of various embodiments of the present teachings.

### DESCRIPTION OF VARIOUS EMBODIMENTS

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

It is noted that, as used in this specification and the appended claims, the singular forms “a,” “an,” and “the,” include plural referents unless expressly and unequivocally limited to one referent. Thus, for example, reference to “a monomer” includes two or more monomers,

According to various embodiments, size-exclusion ion-exchange (SEIE) particles having an ion-exchange core micro-encapsulated by a shell capable of size-exclusion are provided. The terms “micro-encapsulation,” “micro-encapsulated,” or the like, refer to a process of encapsulation on the individual particle level. In one embodiment, a core of liquid, solid, and/or gas is micro-encapsulated with a shell to control access to the core. In various other embodiments, micro-encapsulation can coat the entire exterior surface of the core (and optionally interior surfaces), or it can coat only a portion of the exterior surface of the core (and optionally interior surfaces). In various other embodiments, micro-encapsulation of the core can be irreversible to permanently coat the core, or reversible to release the core upon dissolution of the coating. According to various embodiments, micro-encapsulation can include encapsulation of an agglomerate of core material in a shell. The aggregate can be fused, sintered, pressed, compressed, or otherwise formed together core materials. According to various embodiments, the core material can be a single particle and not an aggregate. As used herein, the term “core” or “core material” can refer to a single particle or an aggregate of particles. The term “shell” refers to coating any portion of the core exterior surface and/or interior surface. The dimensions and formation of the shell are described below. The term “material” refers to any substance on a molecular level or in bulk. As used below, a material can be a liquid and/or solid, e.g. an emulsion or a resin.

As used herein, a “mixture” can refer to more than one SEIE particle used together in a packed column, a mixed-bed, a homogenous bed, a fluidized bed, a static column with continuous flow, or a batch mixture, for example. The mixture can include size-exclusion cation-exchange particles and size-exclusion anion-exchange particles, size-exclusion cation-exchange particles and anion-exchange particles, size-exclusion anion-exchange particles and cation-exchange particles, SEIE particles and inerts, or a combination thereof. The mixture can include any physical configuration known in the art of separations, and any chemical mixture known in the art of ion exchange.

Small molecules, such as, for example, inorganic ions and nucleotides, can penetrate or permeate through the size-exclusion shell and can be retained by or ion-exchanged with the ion-exchange core. The shell can prevent larger ions, such as, for example, DNA fragments, from penetrating or permeating through the shell and reacting with the ion-exchange core.

According to various embodiments, SEIE particles can have many uses such as, for example, in the purification of biomolecules. Applications can include, for example, purification of polymerase chain reaction (PCR) products, purification of DNA sequencing reaction mixtures, and purification of RNA. SEIE particles can also be used for purification and/or separation of, for example, oligonucleotides, ligase chain reaction products, proteins, antibody binding reaction products, oligonucleotide ligation assay products, hybridization products, and antibodies. SEIE particles can also be used for desalting of biological products or reaction mixtures.

SEIE particle, according to various embodiments, combine the benefits of size-exclusion chromatography (SEC) with the benefits of ion-exchange chromatography (IEC). Both SEC and IEC can be used for purification of biomolecules. According to various embodiments, SEC can separate molecules on the basis of their hydrodynamic volume, with larger molecules requiring less eluent, for example, a lesser elution volume, than smaller molecules. In SEC, the larger molecules can elute first. SEC can be used in a “spin column” format for biomolecule purification, wherein the column is not required to continually elute but can, for example, elute with a fixed volume, such as the volume in the sample. In a spin column format SEC, larger molecules can be eluted from the column while smaller molecules remain in the column and can later be discarded. SEC can be used for group separation, for example, for the purification of DNA sequencing reactions or the purification of PCR products, wherein the desired product, for example, a sequencing ladder or a PCR product, can flow through the column while undesirable products, for example, primers and ions that are not of interest, remain trapped in the column. SEC can also be used for desalting applications where salts are retained in the column.

IEC can differ from SEC, for example, in the order of elution of species from a column. According to various embodiments, IEC selectivity can be based on, for example, the charge of the analyte. Larger molecules can have a higher charge, and thus a higher affinity for the IEC resin than smaller molecules. Biopolymers, for example, DNA, have a high affinity for IEC resin because the charge of the species increases linearly with the size of the molecule, such that larger molecules can have a higher charge than smaller molecules. Smaller, lesser-charged species, for example, salts and nucleotides, can rapidly elute from an IEC column while a larger species such as, for example, PCR products or DNA sequencing ladders, can be strongly bound to the IEC column and can elute later, or not elute at all. Thus, IEC and SEC can result in different elution orders, with SEC first eluting larger molecules, and IEC first eluting smaller molecules.

According to various embodiments, SEIE particles can enable high quality separation of biomolecules by combining the effects of SEC and IEC. SEIE particles can use a size-exclusion shell to restrict the ability of large molecules to interact with an ion-exchange core. SEIE particles can combine the high selectivity and binding ability of IEC resins with the size-exclusion benefits of SEC. Small molecules that can penetrate the size-exclusion shell of the SEIE particle can interact with the ion-exchange core and can be retained on the core. Larger, highly charged species can be restricted from interacting with the ion-exchange core by the size-exclusion shell of the SEIE particle. Such larger, highly charged species can remain in solution rather than bind to the ion-exchange core. Larger species that remain in solution can be eluted. Eluting SEIE particles can differ from elution of an SEC column in that additional volume in an SEIE column or bed optionally does not elute the bound material because the bound material is held on the ion-exchange core of the SEIE particles, and can be kept from reacting with an eluent to be removed from the column or bed.

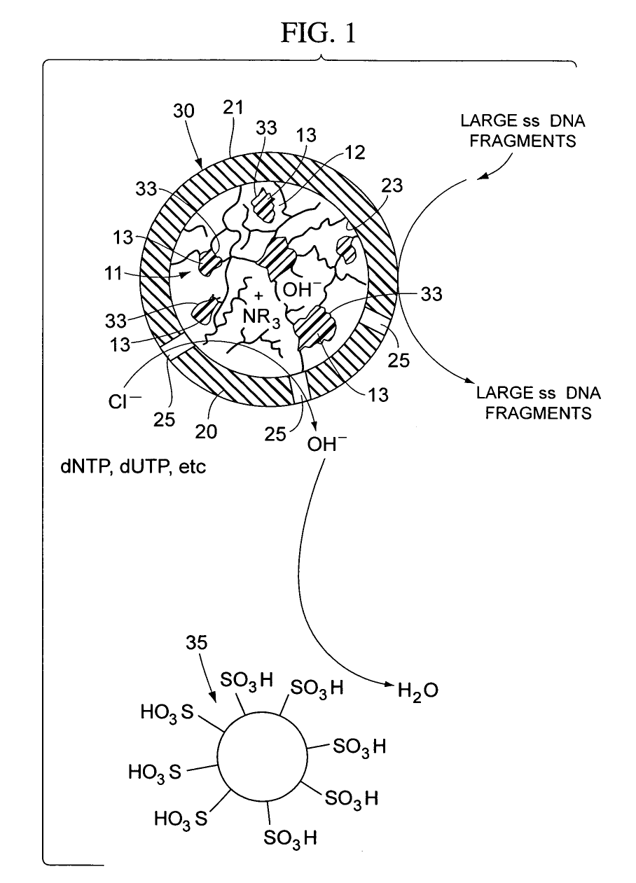

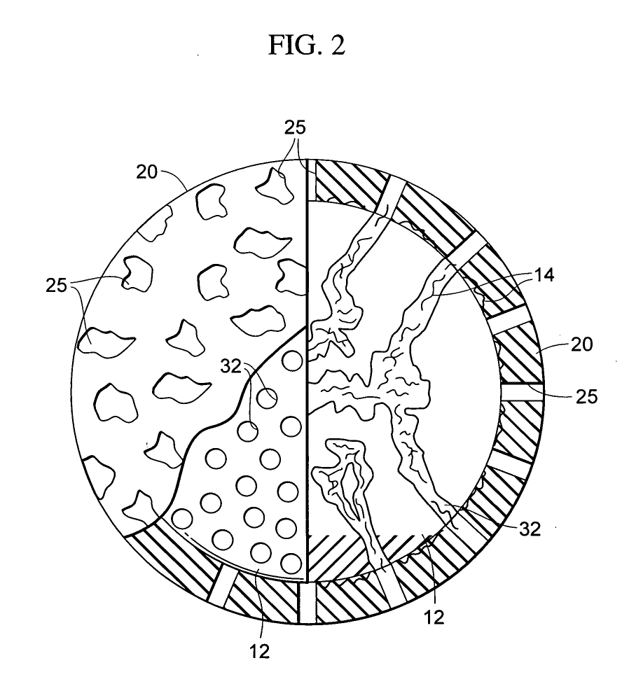

An example of an SEIE particle interaction is shown in FIGS. 1 and 2. FIGS. 1 and 2 are not drawn to scale, and the relation between objects in the figures, such as the relation between core pore sizes and shell pore sizes, is not to scale, and can in fact be inverse, such that the core pore size is larger than the shell pore size. As seen in FIG. 1, large molecules, such as long single stranded DNA (ssDNA) fragments, and double stranded DNA (dsDNA), are too large to pass through a pore 25 of a size-exclusion shell 20 of a size-exclusion anion-exchange particle 30. Instead, large molecules can slide past or bounce off an exterior surface 21 of the shell 20, and remain in solution rather than ion-exchanging with the anion-exchange particle 30. Small molecules, such as deoxynucleotide triphosphates (dNTPs), dye-labeled deoxynucleotide triphosphates, dideoxynucelotide triphosphates (ddNTPs), dye-labeled dideoxynucelotide triphosphates, and small ions, such as chlorine, can pass through the pores 25 of the size-exclusion shell 20 and can undergo ion-exchange with anion-exchange resin 13 at or near the interface 23 of the shell and ion-exchange core 11, or within the pores of ion-exchange core 11. FIG. 1 shows a partial cut-away 33 showing a surface of the ion-exchange core 11 coated with anion-exchange resin 13. The anion-exchange resin 13, for example, a cross-linked, macroporous copolymer of methyl methacrylate and 2-hydroxy-3-methacryloyloxypropyltrimethylammonium chloride, can be present on all internal and external surfaces of the solid core material 12. Together, the anion-exchange resin and solid core material or support 12 form the anion-exchange core 11. Counter-anions released from the anion-exchange core 11, such as hydroxide, can react with a counter-cation, for example, hydronium, of a cation-exchanger 35 that can be provided in a mixture with the SEIE particle 30, to produce a neutral molecule such as water. A cut-away view of the shell and core structure is provided in FIG. 2.

SEIE particles can be used in a mixture, a mixed bed, or a homogeneous bed of particles. Wherein a homogeneous bed of anionic- or cationic-SEIE particles is used, the counter-ion can be released directly into a sample solution upon ion-exchange. In certain cases, the presence of the counter-ion in the sample solution does not affect further processing or reaction of the sample.

According to various embodiments, the selectivity of an SEIE particle can be determined by the nature of the size-exclusion shell, the charge of the ion-exchange core, and the nature of the counter-ion. The properties of the size-exclusion shell can be varied by, for example, choosing appropriate synthesis conditions that can affect the pore size of the resulting shell. Controlling an effective pore size of the size-exclusion shell can allow the SEIE particle to be optimized for different size-exclusion applications.

According to various embodiments, a size-exclusion shell can be a cross-linked or polymerized monomer, such as a hydrogel. As used herein, unless otherwise specified, the terms “polymer,” “polymerization,” “polymerize,” “cross-linked product,” “cross-linking,” “cross-link,” and other like terms, are meant to include both polymerization products and methods, and cross-linked products and methods wherein the resultant product has a three-dimensional structure, as opposed to, for example, a linear polymer. The term “polymer” also refers to oligomers, homopolymers, and copolymers. The degree of cross-linking of the shell can be varied in order to vary the size of the pores of the shell. For example, the pore size of the shell can be large enough to allow relatively small ions, such as, for example, chloride, nucleotides, or other small molecules, to permeate through the shell. The pore size of the shell can be small enough to prevent any relatively large molecules, such as DNA, from permeating through the shell. According to various embodiments, the shell can be hydrophilic to reduce passive adsorption or absorption of biomolecules such as, for example, ssDNA fragments.

According to various embodiments, a shell can be a cross-linked product of two or more reactive monomeric units. The monomeric units can be water-soluble monomeric units. As used herein, the term “water-soluble” includes materials with any degree of water solubility from slightly water-soluble to highly water-soluble, and materials that are swellable in water. The monomeric units can be nitrogen-containing, oxygen-containing, or both. The shell can be a homopolymer, a copolymer, a terpolymer, or another polymer. The shell can be the reaction product of an acrylamide, such as polyacrylamide. The shell can be a reaction product of acrylamide and N,N′-methylenebisacrylamide, or acrylamide and 2,2-bis(acrylamido)acetic acid. The shell can be a reaction product of poly(ethylene glycol) (meth)acrylate and poly(ethylene glycol) diacrylate. According to various embodiments, exemplary water-soluble polymers can include, but are not limited to, poly((meth)acrylamide); poly(N-methyl (methyl)acrylamide); poly(N,N-dimethyl (methyl)acrylamide); poly(N-ethyl (meth)acrylamide); poly(N-n-propyl (meth)acrylamide); poly(N-iso-propyl (meth)acrylamide); poly(N-ethyl-N-methyl (meth)acrylamide); poly(N,N-diethyl (meth)acrylamide); poly(N-vinylformamide); poly(N-vinylacetamide); poly(N-methyl-N-vinylacetamide); poly(vinylalcohol); poly(2-hydroxyethyl (meth)acrylate); poly(3-hydroxypropyl (meth)acrylate); poly(vinylpyrrolidone); poly(ethylene oxide); poly(vinyl methyl ether); poly(N-(meth)acrylylcinamide); poly(vinyloxazolidone); poly(vinylmethyloxazolidone); poly(2-methyl-2-oxazoline); poly(2-ethyl-2-oxazoline); water-soluble polysaccharides, for example, hydroxymethylcellulose and hydroxyethylcellulose; polymers of poly(ethylene glycol) diacrylate; polymers of poly(ethylene glycol) methacrylate; other suitable polymers capable of cross-linking; or a combination thereof. The shell can be neutral, anionic, or cationic. According to various embodiments, the shell can be hydrophilic. The shell can be a cross-linked polymer network of polymers capable of swelling in water, for example, hydrogels. Exemplary hydrogels are described, for example, in U.S. Pat. No. 6,380,456 B1, incorporated herein in its entirety by reference. The shell, once formed, can be non-water soluble. According to various embodiments, the shell can prevent adsorption of ssDNA fragments and/or double-stranded DNA (dsDNA) fragments. According to various embodiments, polymerization can be initiated thermally, photochemically, ionically, or by any other means known to those skilled in the art of polymer chemistry. According to various embodiments, the polymerization can be condensation (or step) polymerization, free-radical polymerization, atomic-transfer free-radical polymerization, living free-radical polymerization, or ring-opening polymerization.

According to various embodiments, the shell can be formed with pores of a pre-determined size. The various pores of a single SEIE particle can be of the same or varying size. The pores can function as size-exclusion openings for preventing molecules larger than a certain size from passing through the shell to the ion-exchange core that is micro-encapsulated by the shell. According to various embodiments, the shell can be formed by cross-linking one or more reactive monomer by addition of a cross-linker, for example, N,N′-methylenebisacrylamide or 2,2-bis(acrylamido)acetic acid. The cross-linker or initiator can be added in an amount of from 0.1 mol % to 95 mol % based on the number of moles of reactive monomer units that can cross-link. According to various embodiments, the cross-linker can be added in an amount of from 0.1 mol % to 70 mol %, from 2.0 mol % to 50 mol %, from 5 mol % to 30 mol %, or from 10 mol % to 20 mol %, based on the number of moles of reactive monomer units that can cross-link. The amount of cross-linker used to form the shell can be at least one factor in determining the size of the pores of the shell, and the size-exclusion ability of the shell. According to various embodiments, the choice of cross-linker, and/or selection of the reaction conditions, can control the amount of cross-linking of the shell. For example, various multifimctional cross-linkers can be used that have varying amounts of functionality. The appropriate amount of a cross-linker to use to form a desired shell pore size can be determined by those of ordinary skill in the art based on the functionality of the cross-linker chosen, the reaction conditions, and other factors as known to those of ordinary skill in the art. The shell pore size can be equal to or smaller than a 10 nt ssDNA. The shell pore size can be equal to or smaller than a 100 nt ssDNA.

According to various embodiments, the shell can be formed by reacting any two of the following that provide cross-linked reaction products: N,N′-methylenebisacrylamide, 2,2-bis(acrylamido)acetic acid, poly(ethylene glycol) (meth)acrylate, poly(ethylene glycol) diacrylate, N,N′-di(meth)acryloylpiperazine, tri(meth)acryloylperhydro-s-triazine.

According to various embodiments wherein 50% or more of the pores of the size-exclusion shell have a pore size capable of excluding a molecule equal to or larger than a 100 nt ssDNA, the shell can permit nucleotides, oligonucleotide primers less than 100 nt in size, and buffer salts, to pass through the shell to the ion-exchange core while molecules 100 nt in size or larger are deflected by the shell. Wherein 50% or more of the pores of the size-exclusion shell have a pore size capable of excluding a molecule equal to or larger than a 100 nt ssDNA, the SEIE particles can be used for purification of biological samples, for example, PCR products, to separate larger DNA, for example dsDNA, from ssDNA, free nucleotides, salts, and ions. When the shell pore size is larger than 100 nt ssDNA, for example, 300 nt, 800 nt, or 1500 nt, the shell permits nucleotides, oligonucleotides, salts and primers less than 300 nt, 800 nt, or 1500 nt, respectively, to pass through.

According to various embodiments wherein 50% or more of the pores of the size-exclusion shell have a pore size capable of excluding a molecule equal to or larger than a 10 nt ssDNA, the shell can permit salts and smaller nucleotides to pass through the size-exclusion shell to react with the ion-exchange core. In embodiments wherein 50% or more of the pores of the size-exclusion shell have a pore size capable of excluding a molecule equal to or larger than 10 nt, the SEIE particle can be used for purification of biological samples, for example, resulting from a sequencing reaction. Purification of a sequencing reaction sample can remove dye-labeled dideoxynucleotides and salts from the sequencing reaction sample by allowing such components to pass through the shell and react with the ion-exchange core, leaving a purified sample containing an amount of ssDNA relative to the pre-filtered amount, in an amount of 70% or more, 80% or more, 90% or more, or 95% or more. When the shell pore size is larger than 10 nt ssDNA, for example, 30 nt, the shell permits nucleotides, oligonucleotides, salts and primers less than 30 nt to pass through. The shell pore size can also be smaller than 10 nt, so long as the pore size still admits a primer having a chain terminator, dye, or other attachment desirous of being separated from a sample, through the shell. For example, the pore size can be 5 nt ssDNA or larger.

It is to be understood that the particles admitted to or deflected from the shell are not necessarily exactly the “pore size” given. That is, admittance to or exclusion from the pore is based on many factors, including actual pore size (wherein each pore of a shell can have a different size), steric hindrance factors, ionic attractions, polarizations, and the like. A “pore size” thus is a mean measurement, providing a guideline that particles larger than the pore size have a higher chance of not passing through the shell, while smaller particles have as larger chance of passing through the shell.

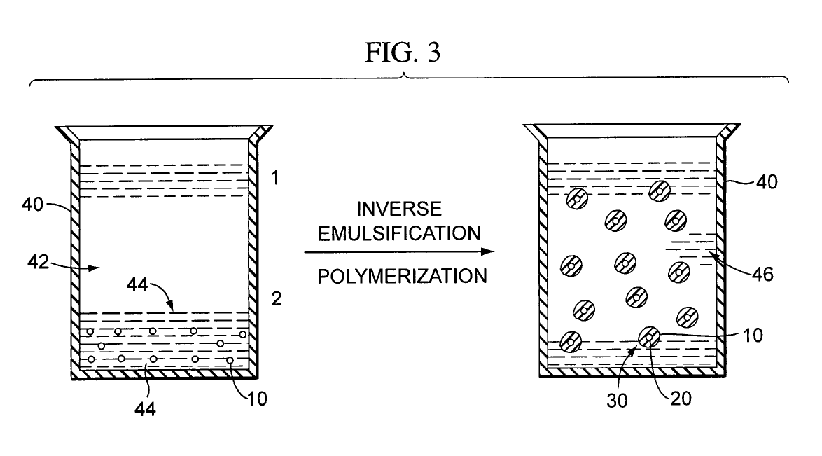

According to various embodiments, a shell can be formed simultaneously with micro-encapsulation of the ion-exchange core. For example, a shell can be formed by inverse emulsion polymerization of a water-soluble reactive monomer, for example, acrylamide, to form a hydrogel. As shown in FIG. 3, an ion-exchange core 10 can be placed in an aqueous monomer solution in a vessel 40. The ion-exchange core 10 can be a surface-activated ion-exchange core. The aqueous monomer solution can include, for example, one or more monomer, for example, acrylamide or N-vinylpyrrolidone, a cross-linker, for example, 2,2-bis(acrylamido)acetic acid, and/or a free radical initiator, for example, sodium persulfate, potassium persulfate, or an azo compound. The solution can further include one or more of a catalyst, a terminator, a chain-stopper, a chain-transfer agent, a promoter, a buffer, and an accelerator.

Next, an oil phase 42 can be added to the vessel 40. The oil phase 42 can include an oil and a surfactant, or an oil including a surfactant. An exemplary oil phase 42 is Petroleum Special (available from Fluka, Buchs SG, Switzerland) and includes a surfactant having a low Hydrophilic Lyophilic Balance (HLB) value, for example, sorbitan monooleate (HLB=4.3). The vessel contents can be subjected to inverse emulsification and polymerization, resulting in the formation of size-exclusion ion-exchange particles 30 having an ion-exchange core 10 micro-encapsulated by a partially cross-linked size-exclusion shell 20 in an aqueous solution 46 in vessel 40. SEIE particles produced by inverse emulsion polymerization can be spherical or nearly spherical in shape, or other shapes depending upon of the shape of the ion-exchange core.

According to various embodiments, a shell can be formed by passing a heated ion-exchange core that is impregnated with an initiator, a catalyst, or both, through a fluidized bed of one or more reactive monomers suitable for forming a shell. The fluidized bed can include, for example, acrylamide and N,N′-methylenebisacrylamide. The monomers and/or polymers in the fluidized bed can be in powder form and can be flowed and/or melted into and onto the ion-exchange core. SEIE particles produced by a fluidized bed reaction can be irregular in shape.

Other methods of forming a shell around an ion-exchange core can be used. The size-exclusion characteristics of the shell can be tailored, modified, changed, or otherwise varied by changing the reaction parameters of the process used to form the shell.

According to various embodiments, a shell can be formed on an ion-exchange core such that the shell has a thickness of from 2% to 300% of the diameter of the ion-exchange core, or from 25% to 200% of the diameter of the ion-exchange core. The thickness of the shell can vary over the surface of the ion-exchange core, or the thickness of the shell can be uniform over the entire surface of the ion-exchange core.

The shell can at least partially micro-encapsulate the ion-exchange core. The shell material can at least partially fill one or more pore or surface feature, for example, pores, cracks, crevices, pits, channels, holes, recesses, or grooves, of the ion-exchange core. For example, an ion-exchange core can be coated on all internal and external surfaces with a monomer suitable for forming a shell. The monomer can be reacted with one or more of a second monomer, a catalyst, or an initiator to form a cross-linked size-exclusion polymer on all surfaces of the ion-exchange core, with the outermost surface of the size-exclusion polymer forming the outermost surface of the size-excluding shell. Large molecules cannot contact the ion-exchange core because of the presence of the polymer forming the size-exclusion shell on all surfaces of the ion-exchange core.

According to various embodiments, the ion-exchange core can be an anionic or cationic material. The ion-exchange core can be a polymer, cross-linked polymer, or inorganic material, for example, silica. The ion-exchange core can be a solid core material capable of ion-exchange, or a solid core material treated with an ion-exchange resin. The ion-exchange core can be surface-activated. The ion-exchange core can be non-magnetic, paramagnetic, or magnetic. Exemplary anionic ion-exchange core materials include those listed below. Other ion-exchange materials, including cationic ion-exchange materials, and materials capable of being made to ion-exchange, as known to those skilled in the art of ion-exchange, can also be used.

Table 1 provides examples of ion-exchange material that can be purchased from a variety of manufacturers. Table 1 lists the composition of the core material, the particle size in microns, the anion exchange capacity in microequivalents per milliliter, the protein binding capacity in milligrams of BSA per milliliter and the ionic form of the material. It will be evident to one skilled in the art that is this only a subset of ion-exchange materials that can be purchased or manufactured for this application.

TABLE 1

| | | | | Anion | Protein | |
|---|---|---|---|---|---|---|
| | | | Particle | Exchange | Binding | |
| | | Core | Size | Capacity | Capacity | ionic |
| Manufacturer | Name | Material | (microns) | (μeq/mL) | (mg BSA/mL) | form |
| BioRad | MacroPrep | PMMA | 50 | 400 | 25 | Cl |
| | HighQ | | | | | |
| BioRad | MacroPrep Q | PMMA | 50 | 190 | 15 | Cl |
| BioRad | MacroPrep Q25 | PMMA | 25 | 220 | 30 | Cl |
| BioRad | Aminex A-27 | PS-DVB | 15 | 1400 | — | acetate |
| BioRad | AG1-X8 | PS-DVB | 45-106 | 1200 | — | Cl |
| Dow | Dowex 1X8 | PS-DVB | 38-74 | 1200 | — | Cl |
| Dow | Dowex 2X8 | PS-DVB | 38-74 | 1200 | — | Cl |
| Alltech | Nucleosil SB - | silica | 5 | — | — | Cl |
| | 5 μm | | | | | |
| EM Science | Fractogel | PMMA | 20-40 | — | 100 | Cl |
| | TMAE (s) | | | | | |
| Spectrum | IE 1X8 | PS-DVB | 40-75 | 1200 | — | Cl |
| TosoHaas | Super Q-650S | PMMA | 20-50 | 250 | — | Cl |
| Iontosorb | TMAHP-100 | Cellulose | 30-50 | 400 | — | Cl |
| (Czech Rep.) | | | | | | |
| Graver Tech. | Powdex | PS-DVB | 30 | high | — | Cl |
| | | | (irreg) | | | |
| Purolite | Chromalite | PS-DVB | 30 | 1500 | — | Cl |
| | 30 SBA | | | | | |
| Mitsubishi Chem | CA08S | PS-DVB | 11 | 1300 | — | Cl |
| Mitsubishi Chem | CA08Y | PS-DVB | 25 | 1300 | — | Cl |
| Transgenomics | ANEX-QS | PS-DVB | 8 | 1500 | — | — |

According to various embodiments wherein the ion-exchange core includes a solid core material capable of ion-exchange, the solid core material can be macroporous silica, controlled pore glass (CPG), a macroporous polymer microsphere with internal pores, other porous materials as known to those of ordinary skill in the art of ion-exchange separation, or a combination thereof. The solid core material can have various surface features, including, for example, pores, cracks, crevices, pits, channels, holes, recesses, or grooves. The solid core material can include sodium oxide, silicon dioxide, sodium borate, or a combination thereof. The solid core material can be modified to be capable of ion-exchange, for example, modification to be capable of cation-exchange or anion-exchange. Modification of the solid core material can include treatment of the solid core material to form cationic or anionic substituent groups on the surfaces of the solid core material. As used herein, the term “surface” can include external surfaces and/or internal surfaces. Internal surfaces can be, for example, the surfaces of voids or pores within the solid core material. The solid core material can be modified to include one or more of quaternized functional groups, at least one carboxylic acid group, at least one sulfonic acid group, other cationic or anionic functional groups known to those of ordinary skill in the art of ion-exchange separation, or a combination thereof, on the surface of the solid core material.

According to various embodiments, the solid core material can be microporous, mesoporous, and/or macroporous. The solid core material can have an average pore size of less than or equal to 1000 Angstroms, for example, from 100 Angstroms to 1000 Angstroms, or less than or equal to 100 Angstroms. The average diameter of the solid core material can be from 0.1 μm to 500 μm, from 1 μm to 250 μm, from 1 μm to 150 μm, from 1 μm to 100 μm, or from 2 μm to 20 μm, for example. The average diameter of the solid core material can be 250 μm or less, 150 μm or less, 100 μm or less, 50 μm or less, or 20 μm or less.

According to various embodiments, a solid core material can adsorb an ion-exchange resin onto the external surface, internal surface, or both the external and the internal surface of the solid core material to form the ion-exchange core. As used herein, the term “resin” can encompass a resin or a gel. The ion-exchange resin can be a cation-exchange resin or an anion-exchange resin. The ion-exchange resin can include one or more quaternized functional groups, one or more non-quarternized amine group, at least one carboxylic acid group, at least one sulfonic acid group, or a combination thereof. Suitable anion-exchange resins and cation-exchange resins would be recognized by those of ordinary skill in the art of ion-exchange in view of the present teachings.

According to various embodiments, the ion-exchange resin can be sequestered into the pores of the solid core material, for example, a macroporous silica particle. Filling at least a portion of the pores of the solid core material and/or coating the external surface of the solid core material with an ion-exchange resin can increase the ion-exchange capacity of the SEIE particle relative to traditional ion-exchange resins. An ion-exchange capacity of an SEIE particle can be improved by increasing a mass of ion-exchange resin, such as quaternary ammonium resin, on the external surfaces and/or on the internal surfaces of the pores of the ion-exchange core. The ion-exchange capacity of an SEIE particle can be improved by appropriate selection of cationic or anionic functional groups on the external surfaces, internal surfaces, or both internal surfaces and external surfaces of the solid core material.

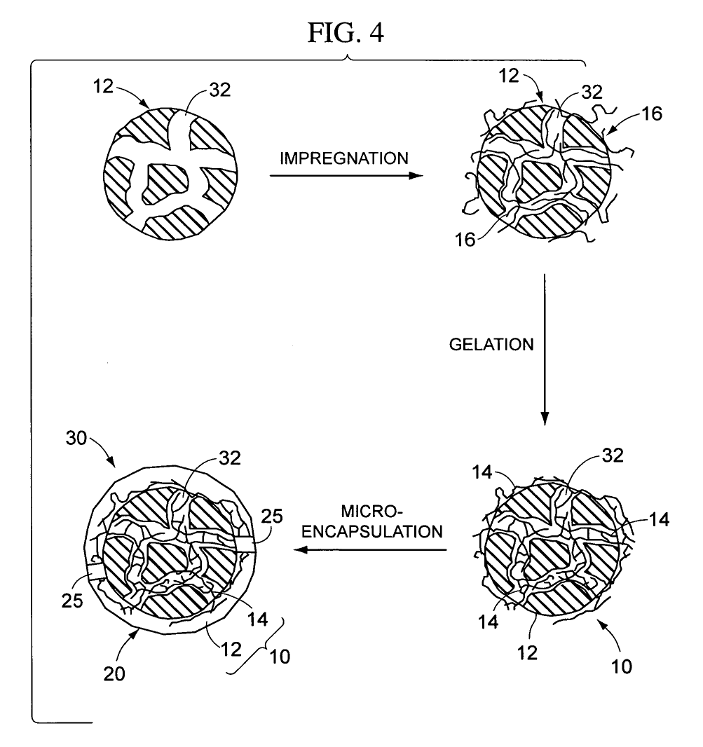

According to various embodiments, the ion-exchange resin can be formed in situ on the solid core material. For example, as shown in FIG. 4, a first monomer 16, pre-polymer or polymer, can be impregnated in the solid core material 12, to include contacting the surfaces of pores 32. The impregnated first monomer 16, pre-polymer, or polymer, can be reacted with a second monomer, compound, or pre-polymer, and, optionally, an initiator, to form a cross-linked ion-exchange resin 14 in situ in and on the solid core material 12, including on the internal surfaces of the pores 32. An ion-exchange core 10 results. The ion-exchange resin can be the product of one or more monomer, one or more prepolymer and/or polymer, or a combination thereof, according to various embodiments. The formed ion-exchange core 10 can be micro-encapsulated, for example, by inverse emulsification and polymerization, by a shell 20 having pores 25 to form a size-exclusion ion-exchange particle 30.

According to various embodiments, an anion-exchange core can be formed and micro-encapsulated by a shell. To form the anion-exchange core, polyethylenimine can be impregnated onto the surface of a solid core material, including onto the internal surfaces of pores of the solid core material. For example, a solid core material of SiO₂ having an average pore size of 1000 Angstroms, a void volume of 0.95 cc/g, and a diameter of 5 μm, can be added to a solution of polyethyleneimine in methanol and incubated for a time sufficient to impregnate the polyethyleneimine into the core and substantially onto all internal and external surfaces of the solid core material. According to various embodiments, polyethylenimine can be adsorbed on the solid core material due to hydrogen bonding with silanol groups in the solid core material. The adsorbed polyethylenimine can then be reacted with a second compound, such as, for example, 1,3-dibromopropane, in a solvent, for example, dioxane, to form a cross-linked network that functions as an anion-exchanger. This cross-linked network can form a swollen gel when added to water. According to various embodiments, the anion exchanger can be quarterized by reacting the cross-linked network with an alkyl halide, resulting in a strong anion-exchanger. The resultant anion-exchange core can be micro-encapsulated by a shell of, for example, polyacrylamide, to form a size-exclusion anion-exchange particle. By methods known to those of ordinary skill in the art of ion-exchange separation, other anion-exchange resins or cation-exchange resins can be impregnated or retained on at least a portion of the internal surfaces, on at least a portion of the external surfaces, or on at least a portion of all surfaces of the solid core material of the ion-exchange core.

An ion-exchange core can be a pellicular ion-exchange core prepared by surface agglomeration. For example, a large, sulfonated, cation-exchange bead can be coated with a layer, for example, 0.1 um, high-capacity anion exchange particles to form a thin shell of high capacity anion exchange material on the surface of the cation-exchange bead. Methods of forming pellicular ion-exchange core are taught, for example, in J. Weiss, Handbook of Ion Chromatography, 1986, and C. Horvath, Pellicular Ion Exchangers, Bonded Stationary Phases in Chromatography, Ann Arbor Science, 1974, both of which are incorporated herein in their entireties by reference.

According to various embodiments, the ion-exchange core can be surface-activated to enhance or aid in formation of the shell around the ion-exchange core. Surface activation of the ion-exchange core can include, for example, derivatization of ion-exchange core functional groups by monomers, absorption of polyanions onto the ion-exchange core by ionic interaction with an ion-exchange resin of the ion-exchange core, passive adsorption onto the ion-exchange core of a neutral and water-soluble or at least partially water-soluble oligomer, polymer, or co-polymer, a neutral and organic soluble oligomer, polymer, or co-polymer, a charged initiator through ionic interaction, or a combination thereof.

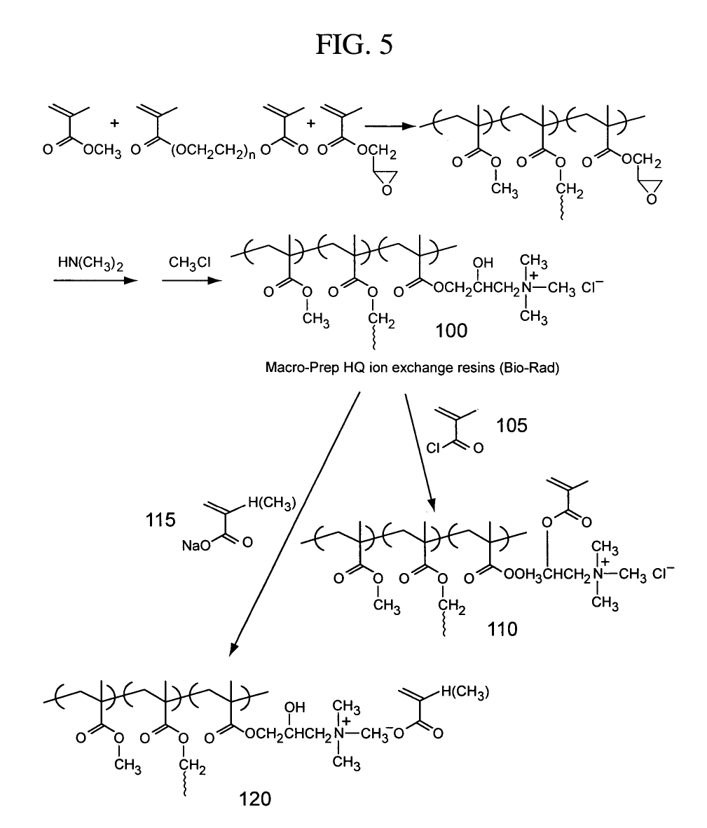

According to various embodiments, the ion-exchange core can be surface-activated by derivatization of ion-exchange core functional groups with acrylic acid or acryloyl chloride. For example, as shown in FIG. 5, an ion-exchange core of Macro-Prep® anion-exchange resin from Bio-Rad can be derivatized. The anion-exchange resin 100 is formed with anion-exchange quarternary ammonium groups attached to the backbone through an epoxy co-monomer linkage. Hydroxyl groups are left on the anion-exchange resin 100 after quarternization, and the hydroxyl groups are subject to further modification. Reacting anion-exchange resin 100 with acryloyl chloride 105 provides surface-activated anion-exchange resin 110 having acryloyl groups useful for grafting the shell polymer onto the anion-exchange core. As shown in FIG. 5, anion-exchange resin 100 can also be surface-activated by adsorbing negatively charged acrylic acid 115, or its anionic version, by ionic interaction, onto the surfaces of the positively charged anion-exchange resin 100. This surface-activation provides a surface-activated anion-exchange resin 120 which can co-polymerize with a pre-polymer or monomer to form a shell around the anion-exchange core. Other derivatizations known to those of ordinary skill in the art of polymer chemistry can also be used to surface-activate a cationic or an anionic ion-exchange core.

According to various embodiments, an ion-exchange core can be surface-activated by absorption of charged or neutral polymers onto the surface of an ion-exchange resin that forms at least part of an ion-exchange core. For example, an anion-exchange resin can be surface-activated by adsorbing a negatively charged polymer, for example, a polyanion. The polyanion can be, for example, poly(meth)acrylic acid; copolymers of (meth)acrylic acid with one or more of (meth)acrylamide, N-methyl (meth)acrylamide, N-ethyl (meth)acrylamide, N-iso-propyl (meth)acrylamide, N-n-propyl (meth)acrylamide, N,N-dimethyl (meth)acrylamide, N-ethyl-N-methyl (meth)acrylamide, N,N-diethyl (meth)acrylamide, N-vinylpyrrolidone, N-vinylacetamide, N-vinylformamides, N-methyl-N-vinylacetamide, 2-hydroxyethyl (meth)acrylate, 3-hydroxypropyl (methyl)acrylate, poly(ethyleneglycol) acrylate, poly(ethyleneglycol) methacrylate, vinylmethyl ether, vinyl alcohol precursor, vinyloxazolidone, vinylmethyloxazolidone, N-(meth)acrylylcinamide; or a combination thereof. The acrylic moiety of the polyanion enables the polyanion to anchor itself onto the surface of the anion-exchange resin by ionic interaction. Without being bound by theory, it is believed that, according to various embodiments wherein the polyanion is a (meth)acrylamide moiety or an N,N-dimethyl (meth)acrylamide moiety, these moieties enable the partition of the monomer, co-monomers, and their polymerization products, for example, oligomers, onto the surfaces of the core resin. These partitioned monomers, co-monomers, and their polymerization products can become an integral part of the shell during the micro-encapsulation process.

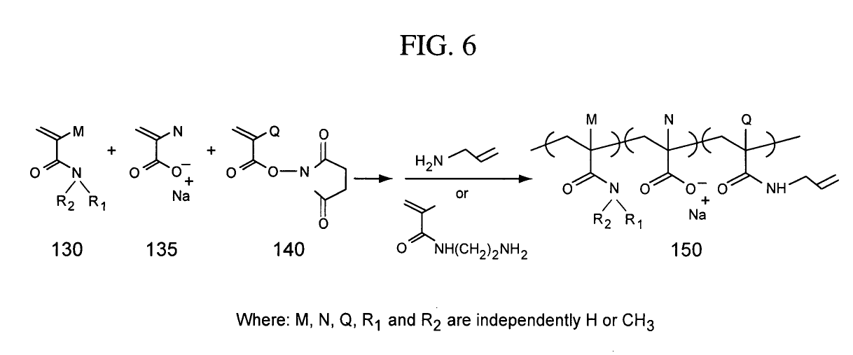

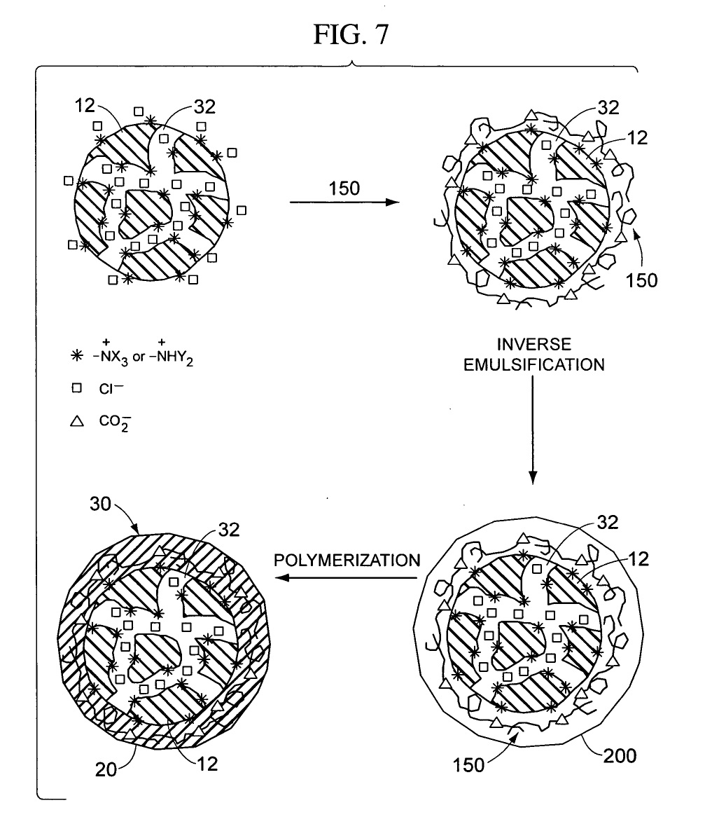

As shown in FIG. 6, for example, a reactive (polymerizable) polyanion 150 can be formed by copolymerizing acrylamide 130, acrylic acid 135, and an NHS ester of acrylic acid 140. As shown in FIG. 7, the resulting reactive polyanion 150 having negatively charged CO₂⁻ groups (designated as Δ) can be anchored onto the surface of an anion-exchange resin of an anion-exchange core 12, wherein the resin has positively charged groups of ⁺NX₃ and/or ⁺NHY₂ (both designated as *) on the surface and/or in the pores of the core 12, where X and Y are independently selected from CₙH₂ₙ₊₁, and n is an integer greater than or equal to 1, and wherein the resin has negatively charged chloride Cl⁻ groups (designated as □) in the pores of the core. Inverse emulsification forms a water shell, or a water jacket, 200 around the anion exchange core 12 and reactive polyanion 150. The water shell 200 comprises reactive monomer, comonomers, crosslinker, and initiator dissolved therein. Polymerization of the water shell 200 can form a shell 20 around the ion-exchange core 12, resulting in the formation of an SEIE particle 30. The reactive allyl groups or acrylamido groups of polyanion 150 afford grafting of the shell onto the anion-exchange resin of the ion-exchange core 12.

According to various embodiments, an ion-exchange core can be surface-activated by passive adsorption of a neutral, water-soluble or organic soluble polymer, onto the ion-exchange core. The neutral, water-soluble or organic soluble polymer can be, for example, poly(N-vinylpyrrolidone) or copolymers thereof; poly(vinyl acetate-co-vinyl alcohol); polyacrylamide or copolymers thereof; poly(N,N-dimethyl acrylamide) or copolymers thereof; poly(N-vinylamides) or copolymers thereof; poly(ethyleneoxide-co-propyleneoxide); amphiphilic diblock and amphiphilic block copolymers, for example, poly(styrene-b-2-hydroxyethyl (meth)acrylate), poly(styrene-b-(methyl)acrylamide), poly(styrene-b-N,N-dimethyl (meth)acrylamide), poly(styrene-b-ethyleneoxide), poly(dimethylsiloxane-b-2-hydroxyethyl (meth)acrylate), poly(methyl (meth)acrylate-b-(meth)acrylamide), poly(methyl (meth)acrylate-b-N,N-dimethyl (meth)acrylamide), poly(methyl (meth)acrylate-b-ethyleneoxide), and poly(methyl (meth)acrylate-b-2-hydroxyethylacrylate); or a combination thereof.

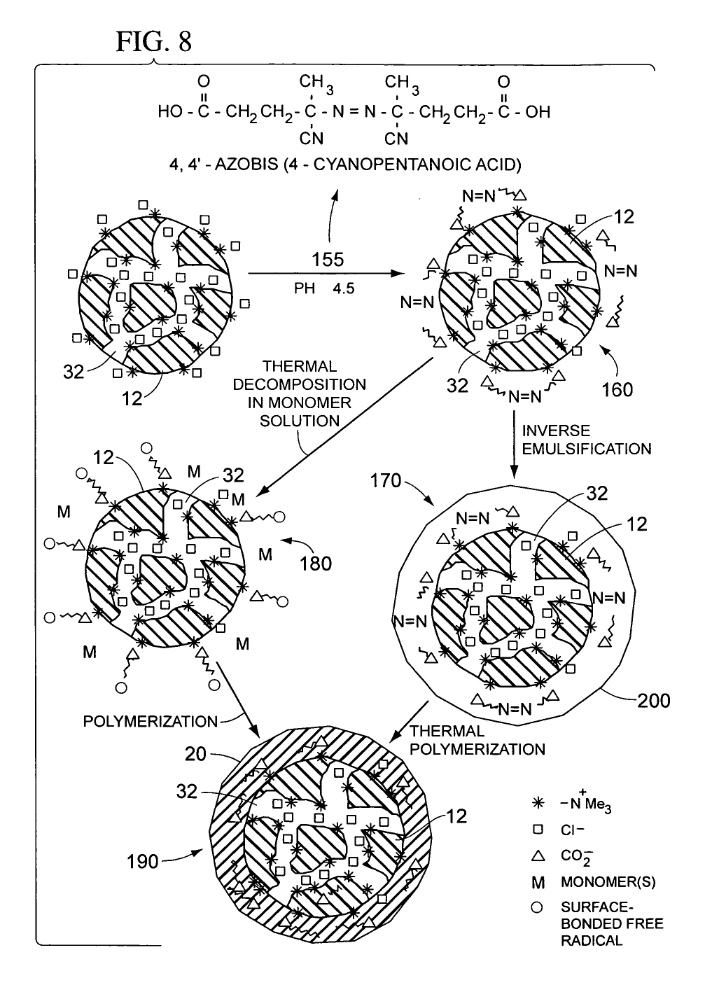

According to various embodiments, an ion-exchange core can be surface-activated by ionic-interaction with a charged initiator, for example, a photo-initiator or a thermal initiator containing one or more negatively charged functional group. For example, as shown in FIG. 8, an initiator 155 can be provided in the form of 4,4′-azobis(4-cyanopentanoic acid) that contains two carboxylic acid groups per molecule. The initiator 155 with ionic group CO₂⁻ (designated as Δ) can be adsorbed onto the surface of an anion-exchange core 12 having ionic groups of ⁺NME₃ (designated as *) and Cl⁻ (designated as □), to form a surface-activated ion-exchange core 160. The surface-activated ion-exchange core 160 can be subjected to inverse emulsification to form a water shell, or a water jacket, 200 around the surface-activated ion-exchange core 160. Water shell 200 comprises reactive monomer, comonomers, and cross-linker dissolved therein. Water shell 200 and core 160 form structure 170, which can be thermally polymerized to form an SEIE particle 190 having a shell 20. According to various embodiments and as shown in FIG. 8, initiator 155 on the surface of ion-exchange core 160 can undergo thermal decomposition in an aqueous or a non-aqueous monomer solution that includes a monomer, for example, N,N-dimethylacrylamide, and a cross-linker, for example, 2,2-bisacrylamidoacetic acid, to form a structure 180 with surface-bonded free radicals (designated as ∘) that initiates free-radical polymerization to form an SEIE particle 190 having a shell 20.

Purification of a sample within the ion-exchange core can be by ion-exchange. Each charge equivalent that can be absorbed on the ion-exchange core can release an equivalent charge into an appropriate solution. According to various embodiments, this displacement of counter-ions from the ion-exchange core can release a large number of counter-ions into a sample solution. In the case of an ion-exchange core in a chloride form, for example, the sample solution can increase in chloride ion concentration. The selectivity of the ion-exchange core can be greater for the ion to be removed from the sample solution than for the counter-ion of the ion-exchange core. For example, if the ion-exchange core is an anion-exchange core in chloride form, wherein the counter-ion is chloride, the ion to be removed from the sample solution can have a greater affinity for the anion-exchange core than the chloride counter-ion, in order to replace the chloride ion in the resin and release the chloride ion into the sample solution. If the counter-ion is chloride, some ions, such as hydroxide or phosphate, can be retained by an anion-exchange core in low quantities because these anions have an affinity for the anion-exchange core similar to that of chloride ions.

According to various embodiments, an anion-exchange core can have a hydroxide counter-ion, such that hydroxide can be released when an ion with affinity for the anion-exchange core is retained on the anion-exchange core. If a hydroxide counter-ion is used, chloride ions can be weakly attracted to the anion-exchange core because chloride and hydroxide have a similar affinity for charge. A cation-exchanger or size-exclusion cation-exchange particle in protonated form can be used with a size-exclusion anion-exchange particle having a hydroxide counter-ion to drive the reaction of the sample solution forward, and to improve retention of low affinity ions, such as chloride ions.

According to various embodiments, an ion-exchange core can contain a lower mobility counter-ion, for example, octane sulfonate. An ion-exchange core can contain a volatile counter-ion, for example, acetate for an anion-exchange material, or ammonium for a cation-exchange material. The volatile counter-ion, such as acetate or ammonium, can later be removed from a sample solution. The counter-ion for an anion-exchange core can be, for example, a halide or hydroxide. The counter-ion for a cation-exchange core can be, for example, hydrogen.

According to various embodiments, a mixed bed including an SEIE particle and an ion-exchange resin can be desirable in order to drive the removal of ions, such as salt ions and counter-ions released from the SEIE particle, from the sample solution. For example, a size-exclusion anion-exchange (SEAE) particle can be combined with a bare cation-exchange resin such that the counter-ions released from the SEAE particle react with counter-ions released from the cation-exchange resin to form neutral compounds, such as water, or volatile substances which can be driven from the mixed bed during the reaction. Whether neutral or volatile, the generation of such inert or separable products drives forward the retention of ions from a sample solution by the SEAE particles. A mixed bed of a size-exclusion cation-exchange (SECE) particles and a bare anion-exchange resin can be used. SEAE particles and SECE particles can form a mixed bed.

According to various embodiments, a mixed bed ion-exchanger can include an SEAE particle having an anionic ion-exchange core in hydroxide form. A mixed bed can be used for bulk phase desalting of a sample solution. An SEAE particle can be prepared in the hydroxide form and can be mixed with an SECE particle or cation-exchange resin prepared in the hydrogen form, to form a mixed bed. An anion in a sample solution can displace a hydroxide ion from the SEAE particle to become bound to the ion-exchange core thereof. The hydroxide ion can cause the sample solution to become basic. With a mixed bed, the hydroxide ion released from the SEAE particle and the hydronium ion released from the cation-exchange resin or SECE particle can react irreversibly to form water, continually removing hydroxide and hydronium from the sample solution, and maintaining a low ionic strength of the sample solution. The mixed bed can drive the removal of lower affinity anions such as, for example, chloride, from solution. The mixed bed can maintain a stable pH of the sample solution. The mixed bed can drive adsorption of anions and cations from the sample solution onto the respective SEAE and SECE particles. A mixed bed can desalt a sample solution. According to various embodiments, a SEAE particle with an ion-exchange core in hydroxide form can be mixed with a stoichiometrically equal amount of cation-exchange resin or SECE particles in the hydrogen form.

According to various embodiments a high capacity de-salting/cleaning agent can be formed by a mixture of SEAE particles, for example, in hydroxide form, or anion-exchange resin, for example, in hydroxide form, and a protonated conventional cation-exchange resin or protonated SECE particles. The volume of the de-salting/cleaning agent is a function of the ionic capacity of the resin and can be less than the volume of a sample solution, to effect de-salting/cleaning of the sample solution.

According to various embodiments, a mixed-bed can include SEAE particles and SECE particles, for example, in a stoichiometrically equivalent amount, SEAE particles and a cation-exchange resin, for example, in a stoichiometrically equivalent amount, or SECE particles and an anion-exchange resin, for example, in a stoichiometrically equivalent amount. In a mixed bed, the amount of material capable of anion-exchange, for example, SEAE particles or an anion-exchange resin, can be stoichiometrically different from an amount of material capable of cation-exchange, for example, SECE particles or cation-exchange resin.

According to various embodiments, a mixed-bed can include SEAE particles and SECE particles, for example, not in a stoichiometrically equivalent amount, SEAE particles and a cation-exchange resin, for example, not in a stoichiometrically equivalent amount, or SECE particles and an anion-exchange resin, for example, not in a stoichiometrically equivalent amount. Mixed ion-exchangers not in a stoichiometrically equivalent amount provide excess capacity for either anion exchange or cation exchange.

An exemplary PCR product solution can contain amplified target sequences (amplicons), buffer salts, metal ions, enzymes (e.g. polymerase), nucleotides, oligonucleotide primers, and other components. According to various embodiments, PCR products can be analyzed, or used in subsequent enzymatic reactions that can be sensitive to at least some of the artifacts found in a sample solution containing the PCR products. For example, free nucleotides and oligonucleotide primers can interfere with downstream enzymatic reactions. A size-exclusion limit of an SEIE particle can be, for example, a 100 nt ssDNA. An SEIE particle can trap and remove, for example, nucleotides, oligonucleotide primers, and buffer salts, that are less than 100 nt or an equivalent size. The resulting solution can contain purified PCR products in a desalted environment, and can be used in downstream reactions and analyses. PCR purification can be directed toward separating larger double stranded DNA (dsDNA) from smaller ssDNA, and dsDNA (e.g. primer-dimer, an unwanted side reaction product which is a dsDNA), free nucleotides, and salts. PCR product purification using SEIE particles can isolate, for example, a 250-600 bp amplicon and can remove 44 nt primers, nucleotides, or both.

DNA sequencing reaction solutions can contain, for example, buffer salts, metal ions, polymerase, nucleotides, oligonucleotide primers, and other components. SEIE particles for the purification of sequencing reaction solutions, however, can differ from those used in the purification of PCR reaction solutions. For example, according to various embodiments, sequencing reaction products can contain residual, unincorporated dye-labeled dideoxynucleotides (terminators) that can be removed prior to electrophoretic analysis and DNA sequencing or basecalling. Failure to remove such compounds can result in “blobs” that can cause errors in DNA sequencing or basecalling. Capillary sequencers can use electrokinetic injection as a means to introduce DNA sequencing reaction samples. The presence of salts in the samples can effect the introduction of the sample into the capillary, where a reduced salt concentration can be required for injection into the capillary. DNA sequencing reaction samples can be desalted by purification with SEIE particles. A sample solution purified with SEIE particles can have a salt concentration of less than or equal to 100 μM. A sample solution purified with SEIE particles can have a salt concentration of less than or equal to 50 μM. A sample solution purified by SEIE particles can be suitable for electrokinetic capillary injection. For these and other purposes, the SEIE particle can have a size-exclusion limit of, for example, less than 10 nt ssDNA, and can be able to remove small ions such as salts and dye-labeled nucleotides from a sample solution while leaving ssDNA free in solution. Sequencing reaction purification using SEIE particles can be used to separate ssDNA, for example, having a size of from 10 nt to 1500 nt or larger in size, from smaller components such as, for example, dye-labeled nucleotides and salts.

According to various embodiments, DNA purification can occur in a bulk mode using SEIE particles. A well-formed chromatographic bed of SEIE particles is not necessarily required.

According to various embodiments, a device including SEIE particles as described herein, is provided. The device can be a microfluidic device having one or more pathway, wherein at least a portion of at least one pathway contains the SEIE particles. The device can have an inlet and an outlet in fluid communication with the SEIE particles. The particles can be present in, for example, a column. As used herein, a column can be in a horizontal or vertical orientation, or in any position between a horizontal and a vertical orientation. The column can include a cavity, chamber, reservoir, well, reaction region, bed, recess, or other receptacle suitable for containing or retaining SEIE particles and a sample solution. The column can contain one or more SEIE particles. The outlet of the device can be in fluid communication with a receptacle, such as a purified sample well, a tube, a glass plate, or another means of collecting a purified sample.

According to various embodiments, a method using such a device is provided for purifying a sample solution. The device can include size-exclusion ion-exchange particles, such as size-exclusion anion-exchange particles, size-exclusion cation-exchange particles, or a combination thereof. The method can include adding the particles to the column of the device. A bare cation-exchange resin, anion-exchange resin, or both, can optionally be added to the column of the device. A sample, for example, a PCR purification product solution or a sequencing reaction product solution, can be placed in or introduced to the inlet of the device. The sample can travel from the inlet through the column containing SEIE particles and optional additional ion-exchange resin. The sample can be subjected to a combination of size-exclusion separation and ion-exchange resulting in a filtration and/or purification of the sample. The filtered and/or purified solution can be eluted or removed from the column through the outlet, and can be directed to a receptacle for analysis and/or further processing. The sample can be moved through the column by centripetal force.

According to various embodiments, purification of a sample using SEIE particles can be achieved using a volume of SEIE particles that is sufficient to provide adequate ion-exchange capacity, such as, ion-exchange of at least 80%, at least 90%, or at least 95% of the sample. The purification can occur in ten minutes or less, five minutes or less, or two minutes or less. The purification can include contacting a sample with the SEIE particles for a period of time sufficient for the SEIE particles to ion-exchange with the sample, and removing the purified sample from the SEIE particles.

According to various embodiments, separating the purified sample from the particles can comprise removing the purified sample from the particles, removing the particles from the purified sample, and/or sampling the purified sample from the mixture of particles and purified sample. An example of sampling the purified sample from the mixture of particles and purified sample comprises analyzing the product in a tube by dipping a capillary directly into the tube and injecting into a sequencer.

Exemplary embodiments of various aspects of the invention are described herein. The above description and following examples are meant to be exemplary only, and various modifications and substitutions for methods and materials described herein will be apparent to those of ordinary skill in the art and are intended to be covered by the present description.

### EXAMPLES

Formation of SEIE Particles and Mixed Bed:

A solution was prepared from 2.4957 g (35.11 mmol) acrylamide (99+% pure, Aldrich Chemical, St. Louis, Mo.) and 0.7021 g (4.55 mmol) of N,N′-methylenebisacrylamide (99+ pure, Aldrich Chemical) in 11.9391 g of water (Milli-Q Water System, Millipore of Billerica, Mass.). To the solution was added, with swirling, a suspension of 0.7158 g of MACRO-PREP HQ macroporous anion-exchange core (Bio-Rad of Hercules, Calif.) in 2.0075 g of water (Milli-Q Water System, Millipore). The suspension of MACRO-PREP HQ was prepared 30 minutes ahead of time with occasional swirling prior to use. The mixture of monomer solution and the MACRO-PREP suspension was poured into a solution of 1.0072 g of SPAN-80 (sorbitan monooleate, Fluka of Buchs, Switzerland) in 20.10 g of PETROLEUM SPECIAL (bp 180-220° C., Fluka) and stirred at 3600 rpm. Emulsification was carried out at ambient temperature for 2.5 minutes. The emulsion was added to a 24/40 three-necked round bottom flask, equipped with a water-cooled condenser, a bleeding tube for purging, and a mechanical stirrer with a 1″ stainless steel 3-blade propeller. At a stirring speed of 100 rpm, the emulsion was purged by ultra-pure helium at a flow rate of 100 mL/min for 30 minutes. At the beginning of purging, 0.5 mL (0.044 mmol) of a solution of 0.4507 g of ammonium persulfate (99.99+% pure, Aldrich Chemical) in 22.1652 g of water (Milli-Q Water System, Millipore) was added. At the end of purging, the reaction flask was lowered into an oil bath at 45±1° C. and 50 μL (0.33 mmol) N,N,N′N′-tetramethylenethylene-diamine was added to the reaction flask. Polymerization was conducted at 45±1° C. for 5.5 hours. At the end of the reaction time, the reaction mixture was poured into a vessel containing 150 mL of acetone and stirred for 5 minutes. The reaction mixture was suction-filtered through 5 micron filter paper, rinsed with an excess of PETROLEUM SPECIAL and acetone, and suction air dried to yield 3.92 g (quantitative yield) of powdery SEAE particles. The dry SEAE particles were dispersed in 25 mL of 50 mM phosphate buffer (pH=7, J. T Baker of Philipsburg, N.J.) containing 0.5 wt % of polyvinylalcohol (80% hydrolyzed, mw 9-10 Kda, Aldrich Chemical). The phosphate buffer was filtered with a 0.2 micron filter membrane prior to use.

The SEAE particles were converted to the hydroxide form by repeated washing with 1M NH₄OH (Suprapure grade, EMD of Gibbstown, N.J.). The volume of acid or base required to convert a given quantity of resin from one form to another can be calculated knowing the concentration of the acid or base and the ionic capacity of the resin. In practice, the resin is converted with a 10× excess of the needed acid or base. By way of example, 100 μL of particles were vortexed with 800 μL of 1M NH₄OH, spun down in a microcentrifuge at 1000×g, and the supernatant was pipetted off. This process was repeated 10 times. The particles were transferred to a spin column and washed 3 times with 100 μL aliquots of 1M NH₄OH, although this step is optional. The resin bed was washed repeatedly with deionized (DI) water until the effluent was pH neutral (approx. 10 washes with 500 μL aliquots of DI water).

SECE particles were prepared for a mixed bed by a similar process. A commercially available macroporous cation-exchange core, AG 50W-X8, 400 mesh, (Bio-Rad of Hercules, Calif.), was obtained in the protonated form. Note that although the resin is provided in the protonated form, better results are obtained when the resin is converted again. The same process described for converting the SEAE particle to hydroxide form was used to convert the SECE particle to proton form, except washing was performed with 1M HCl (Reagent Grade, J. T. Baker) rather than NH₄OH. The HCl washes were followed by water washes until the effluent was pH neutral. The SEAE particles and the SECE particles were semi-dried by spinning 1 minute at 1000× g. The SEAE particles and the SECE particles were each slurried with 500 μL DI water. The particles were mixed together at a stoichiometric ratio based on the ionic capacity of the anion and cation exchange beads, respectively, and vortexed to form a mixed bed slurry. In order to minimize adsorption of DNA on the bead mixture, the mixed bed was washed twice with sheared salmon sperm DNA (Eppendorf AG of Hamburg, Germany) prepared at a concentration of 1 mg/mL in DI water. A volume of sheared salmon sperm DNA roughly equal to the volume of the resin bed was used for each wash. The bed of beads was washed 3× with 1000 μL aliquots of DI water. The slurry was semi-dried by spinning 1 minute at 1000× g and stored at 4° C. Note that, as described, the mixed bed is washed with salmon sperm DNA before use. However, washing of the constituent beads prior to mixing is equally effective. SEAE and SECE resins when used alone (i.e., not in a mixed bed), can also benefit from washing with salmon sperm DNA.

PCR Purification:

For PCR purification, a sample was prepared containing 102 μL PCR master mix, 4 μL FAM-labeled forward primer (20 pmol/μL), 4 μL reverse primer (20 pmol/μL), 20 μL hgDNA, CEPH 1347-02 (50 μg/μL), and 70 μL deionized water (DI). This master solution was aliquoted into wells in a thermal cycler plate at a volume of 20 μL/well. The mixtures were heated at 95° C. for 5 minutes, followed by 40 cycles of heating, wherein each cycle included heating at 95° C. for 30 seconds, then at 60° C. for 120 seconds.

To perform the purification, 24 mg of the mixed bed SEIE particles formed as described in the Example above (semi-dry, as described above), were weighed into a microcentrifuge tube. 30 μL of the raw PCR product were added and the mixture was agitated for 5 minutes. The microcentrifuge tube was spun at 5000×g and 5 μL of supernatant was removed and pipetted into a 96 well plate for analysis on an ABI 3100 sequencer. The samples were analyzed on the ABI 3100 using a 50 cm array with POP6 polymer and GeneScan® Analysis Software, both from Applied Biosystems, Foster City, Calif.

DNA Sequencing Reaction Purification:

For DNA sequencing reaction purification, a sample was prepared containing 400 μL BIGDYE TERMINATOR READY REACTION MIX (Applied Biosystems, Foster City, Calif.) (v.3), 50 μL M13 universal reverse primer (3.2 pmol/μL), 25 μL template-amplicon (˜100 μg/μL), and 525 μL DI water. This master solution was aliquoted into wells in a thermal cycler plate at a volume of 20 μL/well. The mixture was subjected to 25 cycles of heating, wherein each cycle included heating at 95° C. for 10 seconds, heating at 50° C. for 5 seconds, and heating at 60° C. for 120 seconds.

To perform the purification, 24 mg of the mixed bed SEIE particles formed as described in the Example above (semi-dry, as described above), were weighed and deposited into a microcentrifuge tube. 30 μL of the raw sequencing reaction sample were added and the mixture was agitated for 5 minutes. The microcentrifuge tube was spun at 5000×g and 5 μL of supernatant was removed and pipetted into a 96 well plate for analysis on a ABI 3100 sequencer. The samples were analyzed on the ABI 3100 using a 50 cm array, POP6 from Applied Biosystems, and a standard sequencing module.

Purification of a sequencing reaction can also be done on a smaller scale. For DNA sequencing reaction purification, a sample was prepared containing 8 μL dRhodamine Ready Reaction Mix (Applied Biosystems, Foster City, Calif.), 1.0 μL M13 universal reverse primer (3.2 pmol/μL), 0.5 μL template-amplicon (˜100 μg/μL), and 10.5 μL DI water. This solution was placed in a GeneAmp PCR System 9700 (Applied Biosystems). The mixture was subjected to 25 cycles of heating, wherein each cycle included heating at 95° C. for 10 seconds, heating at 50° C. for 5 seconds, and heating at 60° C. for 120 seconds. A SEAE/cation exchange mixed bed was prepared as previously described. The mixture was prepared as a settled bed by letting the beads settle and then removing any water above the bed. This settled bed was vortexed and a 1 μL aliquot was transferred to 50 μL MicroAmp tube (Applied Biosystems). 1.0 μL of the previously prepared sequencing reaction was added to the beads and pipet mixed for 15 seconds. The tube was transferred to a vortexer and vortexed for 1 minute. 6 μL of DI water was added to the tube, pipet-mixed and centrifuged on a bench centrifuge at 500×g for 30 seconds. The supernatant was removed with a pipet and run on an ABI3100 DNA sequencer. Because the sample is so highly desalted, the injection voltage and time on the sequencer were reduced by a combined factor of 4 so that the data did not go offscale.

Experimental Results:

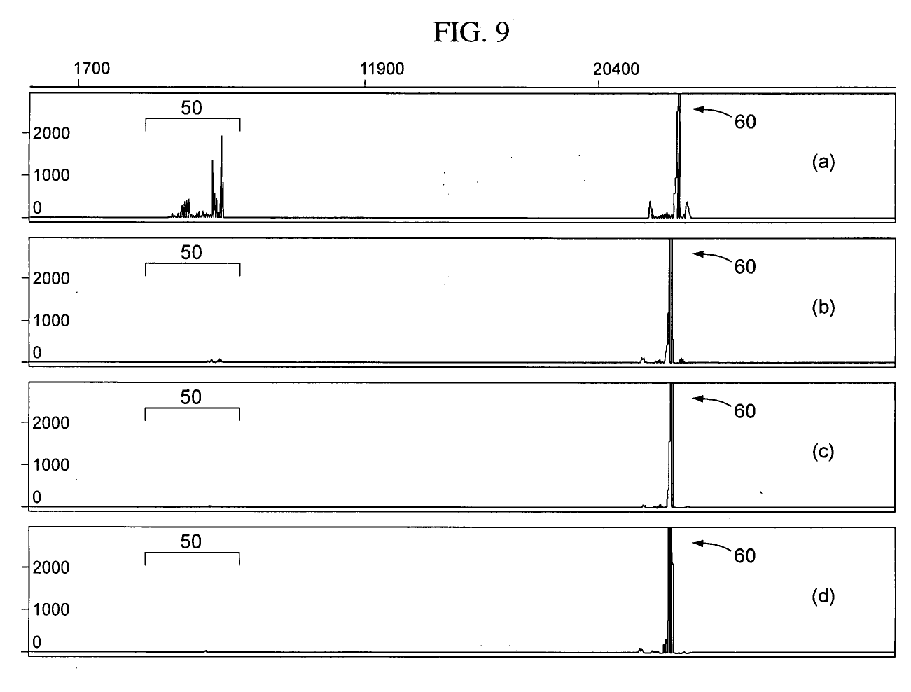

The results of the PCR purification were analyzed using GeneScan software, and are shown in FIG. 9. The experiment was designed to observe the removal of the majority of a dye-labeled 38 nt primer from a 560 bp PCR product while retaining a double stranded DNA amplicon. As the data demonstrate, the primer was initially present in the sample at a high concentration (see graph (a) in FIG. 9), and was reduced in concentration by contact with the SEIE particles. As seen in graphs (a)-(d) of FIG. 9, peaks from 5000-7000 scans, labeled 50, are from the FAM-labeled 38 nt primer, while the peak at 23,000 scans, labeled 60, is the FAM-labeled PCR product. Contact with the SEIE particles for a period of two minutes (graph (b) of FIG. 9) eliminated most of the primer without affecting the PCR product. Contact with the SEIE particles for a period of five minutes (graph (c) of FIG. 9), or a period of ten minutes (graph (d) of FIG. 9), reduced the amount of primer to below a level of detection. Comparison of a ROX-labeled 7 nt single stranded DNA internal standard spiked into each sample showed that the degree of desalting was comparable between each sample and thus the amount injected into each capillary was roughly equal. These results demonstrate that short contact with the mixed bed SEIE resin both desalts and removes primer from a solution containing PCR products and does so with minimal effect on the concentration of a target amplicon.

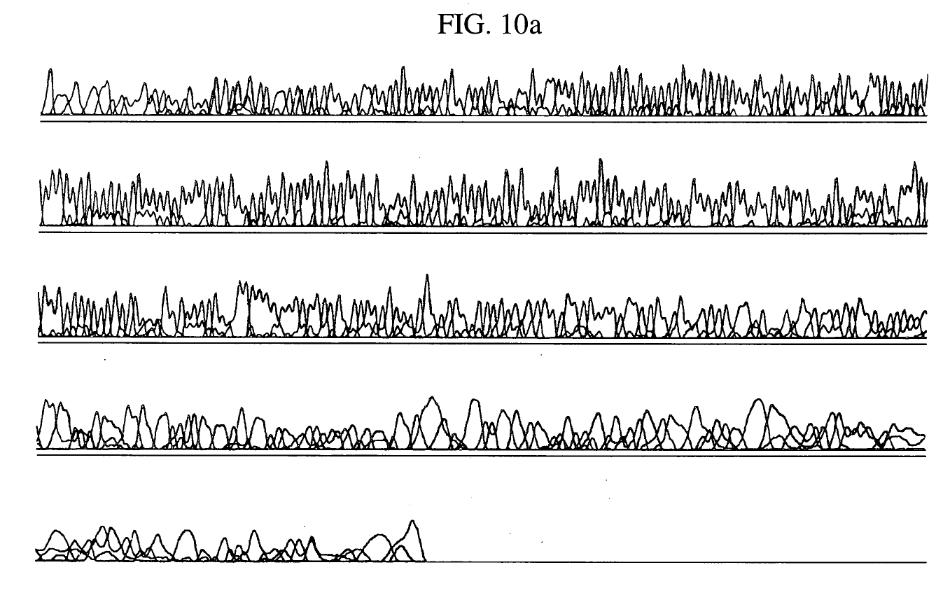

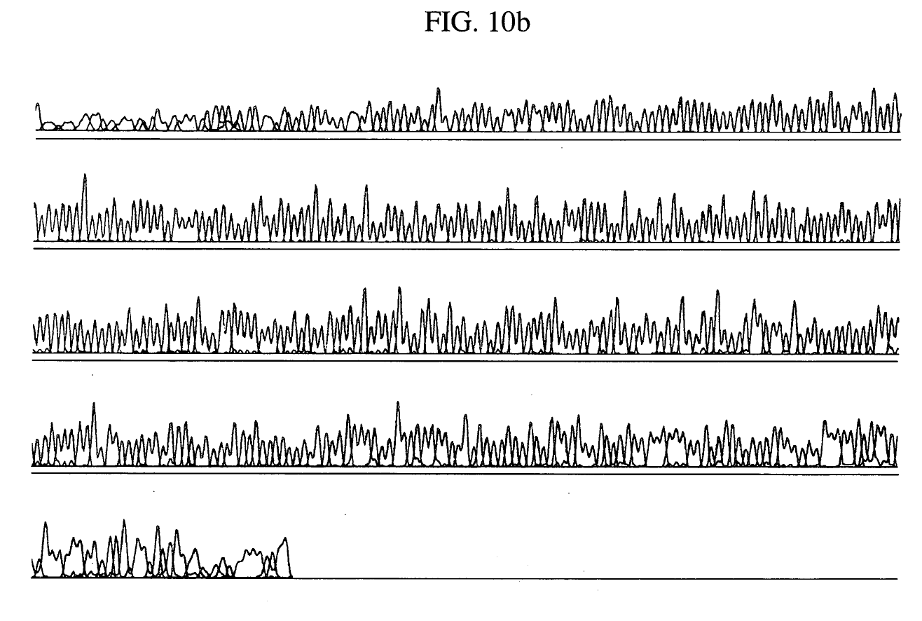

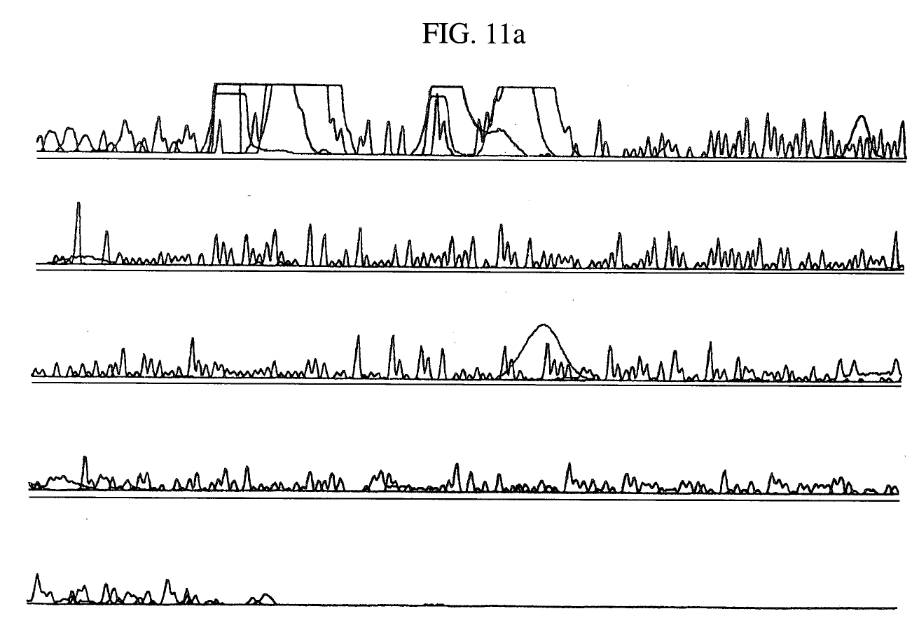

DNA sequencing of a PCR product purified using SEIE particles is shown in FIGS. 10a and 10b. A PCR product, spiked with an excess of primers and nucleotides, was sequenced with and without purification. In both cases, the sequencing reaction was purified using a CentriSep spin column (Princeton Separations, Princeton, N.J., USA). FIG. 10a shows a graphical representation of a detected sequence of an unpurified PCR product. The graph contains much noise and multiple sequences. Several miscalls and ambiguities are visible, and the overall quality is low. FIG. 10b shows a graphical representation of a detected sequence of the same PCR product but purified by contacting the PCR product with the SEIE resin for 10 minutes before sequencing. The sequence of FIG. 10b is clean and readable, unlike the sequence in FIG. 10a.

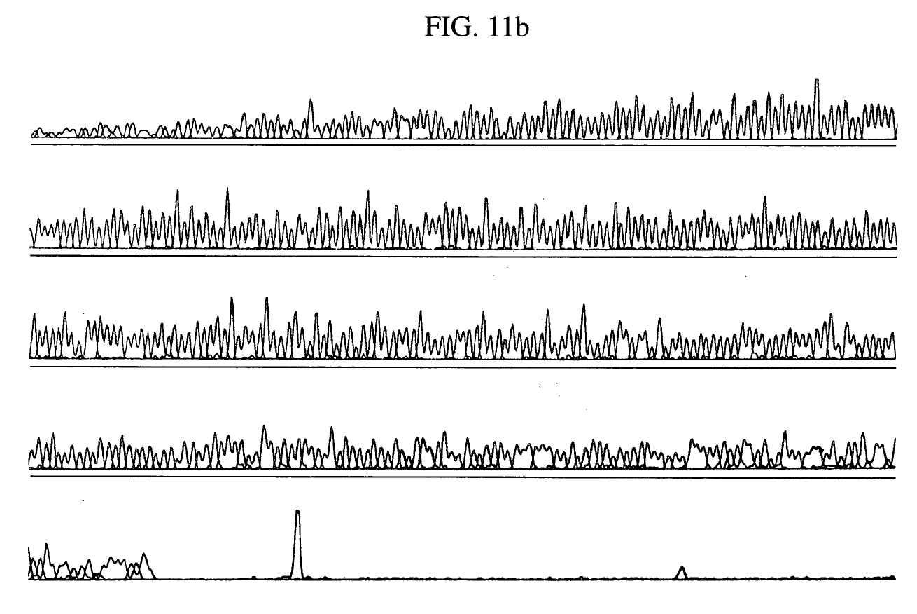

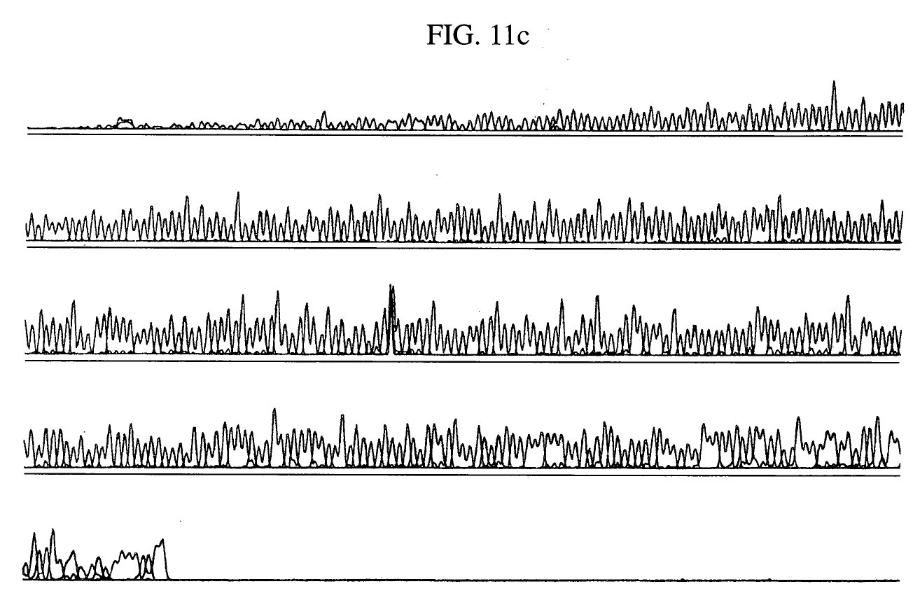

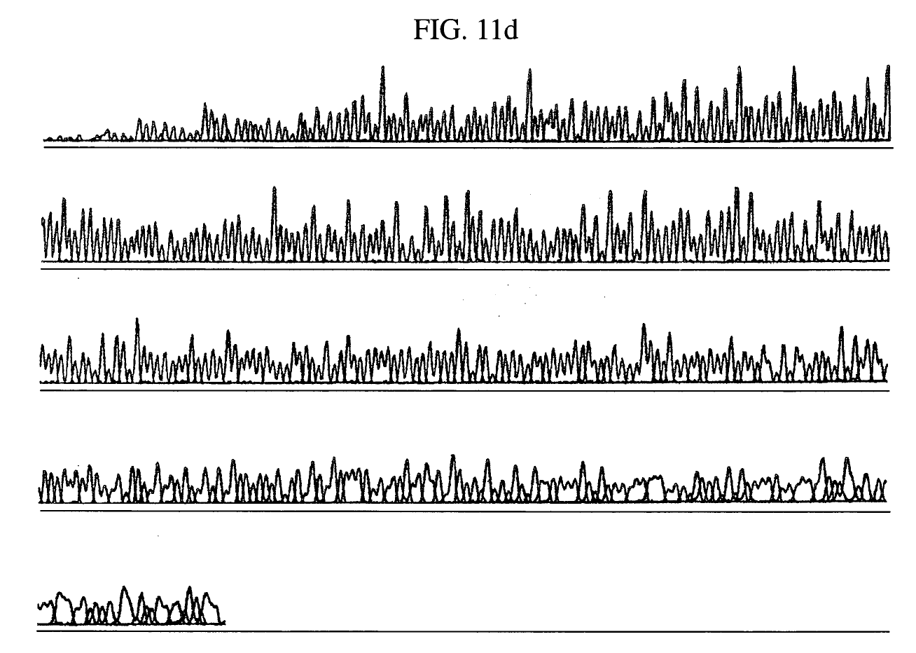

The data in FIGS. 11a-d show the application of SEIE to DNA sequencing reaction product purification. The graph showing the untreated DNA sequencing reaction product sequence (FIG. 11a) has large artifacts (“blobs”) that obscure the sequence data. FIG. 11b shows the result of treatment of a DNA sequencing reaction using a standard CentriSep column. As is evident, the data of FIG. 11b is clearer than that of FIG. 11a. FIGS. 11c and 11d show the result of treating a DNA sequencing reaction product with the mixed bed SEIE particles for three minutes before sequencing. As seen in FIGS. 11c and 11d, with SEIE purification, the “blobs” shown in FIG. 11a are largely gone, and better peak resolution is seen when compared to the graph shown in FIG. 11b. It should be noted that the spike at 295 nt in FIG. 11c was caused by a bubble in the capillary. As seen in FIG. 11c, SEIE purification resulted in the filtering-out of smaller reaction product fragments as reflected at the beginning of the graph. FIG. 11d shows the results on purification of a dRhodamine sequencing reaction as described previously. This purification was performed on a different batch of SEIE resin and at a much smaller scale (1 μL reaction with 1 μL of resin). The results demonstrate that excellent purification can be achieved even when the ratio of sample to resin is less than 1.

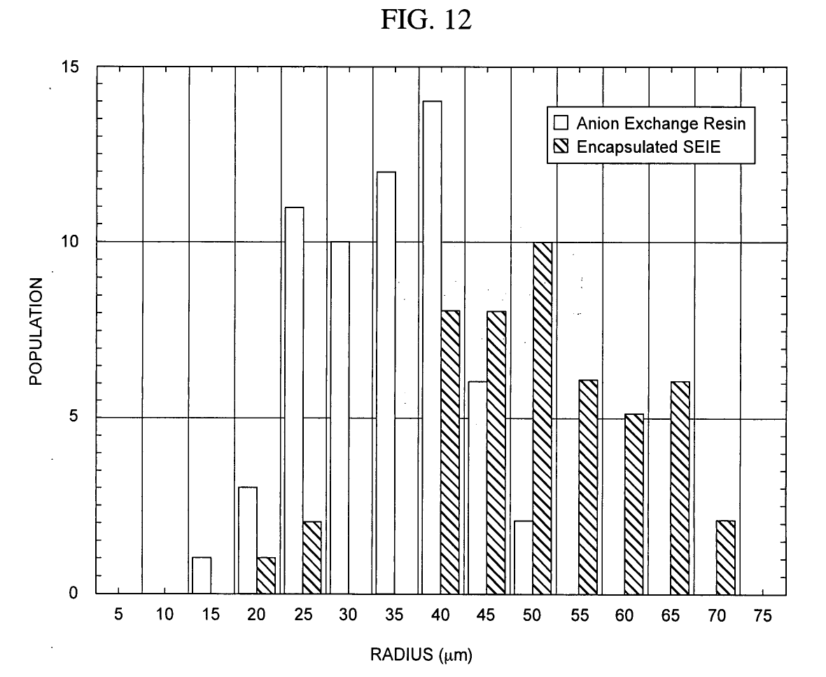

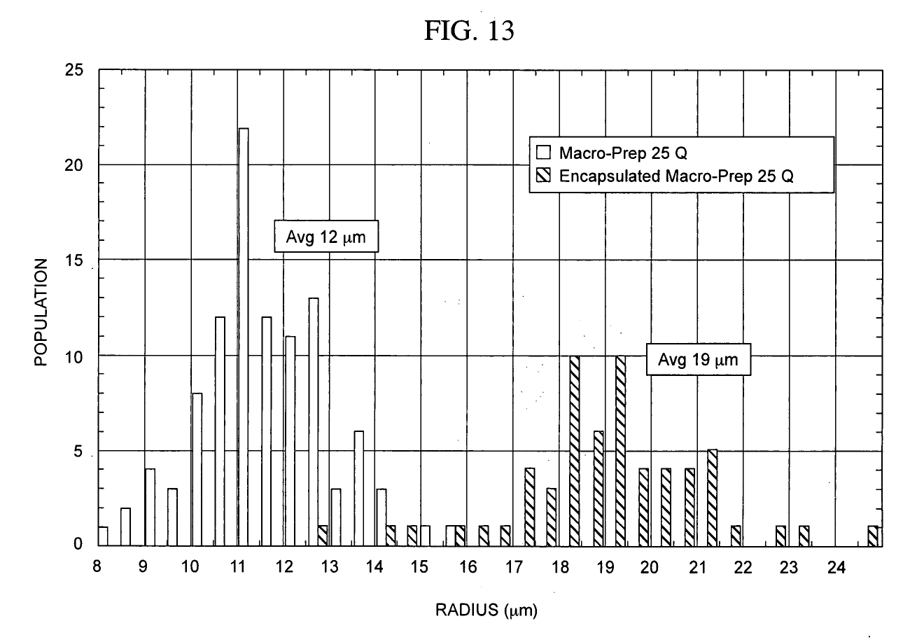

FIGS. 12 and 13 demonstrate the increase in size between an ion-exchange core and a size-exclusion ion-exchange particle. FIG. 12 demonstrates the difference in size between a MACRO-PREP HQ anion exchange resin (25 μm radius) and an SEIE particle made with the resin. FIG. 13 demonstrates the difference in size between a MACRO-PREP 25Q anion exchange resin (average radius 12.5 μm) and an SEIE particle made with the resin according to an embodiment (average radius 19 μm). FIGS. 12 and 13 demonstrate that the SEIE particle has a larger size with respect to the ion-exchange core.

It will be apparent to those skilled in the art that various modifications and variations can be made to various embodiments described herein without departing from the spirit or scope of the present teachings. Thus, it is intended that the various embodiments described herein cover other modifications and variations within the scope of the appended claims and their equivalents.

1.-50. (canceled)

51. A method of purifying a sample, comprising:
providing a plurality of size-exclusion ion-exchange particles, wherein each particle comprises a core for ion-exchange and a shell for size-exclusion;
contacting the sample with the particles to form a purified sample; and
separating the purified sample from the particles.

52. The method of claim 51, wherein the purified sample comprises material having a molecular size of 10 nt ssDNA or greater.

53. The method of claim 51, wherein the purified sample comprises material having a molecular size of 100 nt ssDNA or greater.

54. The method of claim 51, wherein the contacting comprises moving the sample through the plurality of particles using centripetal force.

55. The method of claim 51, wherein the plurality of size-exclusion ion-exchange particles comprise a first volume, the biological sample comprises a second volume, and the first volume is less than or equal to the second volume.

56. The method of claim 51, wherein the purified sample has a salt concentration less than or equal to 50 μM.

57. The method of claim 51, wherein the plurality of size-exclusion ion-exchange particles comprises stoichiometrically equivalent amounts of size-exclusion anion-exchange particles and size-exclusion cation-exchange particles.

58.-60. (canceled)

61. A method of purifying a biological sample, comprising:
providing a plurality of particles, wherein at least some of the particles comprise a ion-exchange portion and a size-exclusion portion;
contacting the biological sample with the particles to form a purified sample, wherein the purified sample comprises:
(a) nucleic acid having a molecular size of 10 nt ssDNA or greater; and
(b) salt having a concentration less than or equal to 50 μM; and
separating the nucleic acid from the particles.

62. The method of claim 61, further comprising:
separating the purified sample from the particles.

63. The method of claim 62, wherein the nucleic acid has a molecular size of 100 nt ssDNA or greater.

64. The method of claim 63, further comprising:
detecting the nucleic acid in the purified sample.

65. The method of claim 61, wherein the ion-exchange portion is an internal surface of the some particles.

66. The method of claim 65, wherein the size-exclusion portion is an external surface of the some particles.

67. The method of claim 61, wherein the particles comprise anion ion-exchange particles.

68. The method of claim 61, wherein contacting comprises adding the particles to the biological sample or passing the biological sample through a column comprising the particles.

69. The method of claim 61, further comprising:
separating the nucleic acid in the purified sample.

70. A method of purifying a biological sample, comprising:
providing the biological sample, wherein the biological sample comprises DNA sequencing reaction products;
providing a plurality of particles, wherein at least some of the particles comprise an ion-exchange property and a size-exclusion property;
contacting the biological sample with the particles to form a purified sample;
separating the purified sample from the particles; and
sequencing the purified sample, wherein the sequencing does not include blobs.

71. The method of claim 70, wherein the purified sample comprises nucleic acid having a molecular size of 10 nt ssDNA or greater, and salt having a concentration less than or equal to 50 μM.

72. The method of claim 70, wherein the particles comprise anion ion-exchange particles.

73. The method of claim 70, wherein contacting comprises passing the biological sample through a column comprising the particles.
